(19) United States
(12) Patent Application Publication
(10) Pub. No.: US 2006/0221610 A1
(43) Pub. Date: Oct. 5, 2006

(54) Light-emitting apparatus having a plurality of overlapping panels forming recesses from which light is emitted

(76) Inventors: Tong Fatt Chew, Loveland, CO (US); Siew It Pang, Loveland, CO (US); Ju Chin Poh, Loveland, CO (US); Fook Chuin Ng, Loveland, CO (US)

Correspondence Address: AVAGO TECHNOLOGIES, LTD., P.O. BOX 1920, DENVER, CO, 80201-1920, US

(21) Appl. No.: 11/097,397

(22) Filed: Apr. 1, 2005

(51) Int. Cl. F21V 7/00; F21V 21/00

(52) U.S. Cl. 362/247; 362/249; 362/241

(57) ABSTRACT

In one embodiment, a light-emitting apparatus includes a substrate having i) a plurality of overlapping panels that form acute angles with respect to an imaginary surface that bisects the overlapping panels, and ii) a plurality of recesses formed between overlapping portions of the overlapping panels. The recesses are open to the first side of the substrate, and the first side of the substrate has a reflective surface. A plurality of light sources is positioned to emanate light from the recesses.

### BACKGROUND

A transmissive liquid crystal display (LCD) is one that requires a backlight to provide its illumination. Often, the backlight comprises a generally planar light-guide having a transparent side, a reflective side, and a plurality of edges. Light from one or more light sources is projected such that it enters one or more of the light-guide's edges, reflects off of the light-guide's reflective side, and is emitted through the light-guide's transparent side. The light sources may take various forms, including those of a cold-cathode fluorescent lamp (CCFL) or light emitting diode (LED) array.

In some cases, a backlight's light-guide is edge-lit by, for example, one or more CCFLs or LED arrays that are positioned adjacent one or more of the light-guide's edges. Exemplary edge-lit light-guides are disclosed in more detail in United States Patent Application Publication 2002/0175632 A1, entitled “LED Backlight”, and in United States Patent Application Publication 2004/0130884 A1, entitled “Backlight Unit of Display Device and Liquid Crystal Display Device Using the Same”.

In other cases, a backlight's light-guide is bottom-lit by, for example, one or more CCFLs or LED arrays that are positioned below the light-guide's reflective side. The light source(s) project light into a secondary light-guide positioned below the primary light-guide. Light exiting this secondary light-guide is then reflected around and into one or more edges of the primary light-guide. Exemplary bottom-lit light-guides are disclosed in more detail in United States Patent Application Publication 2004/0061814 A1, entitled “Backlight Device for Liquid Crystal Display and Method of Fabricating the Same”.

### SUMMARY OF THE INVENTION

In one embodiment, light-emitting apparatus comprises a substrate having i) a plurality of overlapping panels that form acute angles with respect to an imaginary surface that bisects the overlapping panels, and ii) a plurality of recesses formed between overlapping portions of the overlapping panels. The recesses are open to the first side of the substrate, and the first side of the substrate has a reflective surface. A plurality of light sources is positioned to emanate light from the recesses.

Other embodiments are also disclosed.

### BRIEF DESCRIPTION OF THE DRAWINGS

Illustrative embodiments of the invention are illustrated in the drawings, in which:

FIG. 1 illustrates an elevation of a liquid crystal display;

FIG. 2 illustrates a plan view of the backlight shown in FIG. 1;

FIG. 3 illustrates an enlarged view of a portion of the FIG. 1 elevation;

FIG. 4 illustrates an alternate configuration of the substrate shown in FIG. 1;

FIG. 5 illustrates an array of LEDs forming one of the light sources shown in FIGS. 1-3;

FIGS. 6 & 7 illustrate alternate views of an oval-shaped LED;

FIGS. 8 & 9 illustrate plots of luminous intensity for the major and minor axes of the oval-shaped LED shown in FIGS. 6 & 7;

FIGS. 10-15 illustrate various LED mounting configurations;

FIG. 16 illustrates the mounting of various LEDs within a recess of the substrate shown in FIG. 1;

FIGS. 17 & 18 illustrate alternate views of a plurality of LED chips mounted on a substrate; and

FIG. 19 illustrates the placement of a light conditioner in a recess of the substrate shown in FIG. 1.

### DETAILED DESCRIPTION

FIG. 1 illustrates an elevation of a liquid crystal display (LCD) 100. The LCD 100 comprises an LCD panel 102 having a plurality of LCD elements, and a backlight 104 that is positioned behind the LCD panel 102 so as to project light through the LCD panel 102. Optionally, the LCD 100 may comprise one or more light conditioners 106, 108, 110 positioned between the LCD panel 102 and backlight 104. The light conditioners may include one or more light diffusing layers (e.g., a diffuser 106), one or more prismatic layers (e.g., a brightness enhancement film (BEF) 108), and/or one or more light polarizing layers (e.g., a dual brightness enhancement film (DBEF) 110). These light conditioner layers 106, 108, 110 may take the form of elements, sheets or films that are positioned between, or applied to, one or both of the LCD panel 102 and the backlight 104.

As shown in FIGS. 1 & 2, the backlight 104 comprises a substrate 112 having a plurality of overlapping panels 114, 116, 118 that form acute angles with respect to an imaginary surface 120 that bisects the overlapping panels 114, 116, 118, and a plurality of recesses 122, 124, 126 that are formed between overlapping portions 128, 130 of the overlapping panels 114, 116, 118. The recesses 122, 124, 126 open to a side of the substrate 112 having a reflective surface 132, 134, 136.

The backlight 104 further comprises a plurality of light sources 138, 140, 142 that are positioned to emanate light from the recesses 122, 124, 126. In some cases, the light sources 138, 140, 142 may be positioned in the recesses 122, 124, 126. In other cases, the light sources 138, 140, 142 may be positioned such that they extend into the recesses 122, 124, 126, or such that they project light into the recesses 122, 124, 126. Preferably, the light sources 122, 124, 126 are positioned such that their emitted light is at least partially blocked by overhanging surfaces 144, 146, 148 of the recesses 122, 124, 126. If the overhanging surfaces 144, 146, 148 are reflective, light rays originating from the light sources 122, 124, 126 may primarily reflect off 1) the surfaces 144, 146, 148, 150, 152, 154 of the recesses 122, 124, 126, and 2) the reflective side 132, 134, 136 of the substrate 112.

In one embodiment, a light conditioner 106 is positioned over the reflective side 132, 134, 136 of the substrate 112 so as to condition and pass light that is reflected from the substrate 112. The positions of the light sources 138, 140, 142, as well as the heights and widths of the recesses 122, 124, 126, may be selected such that light rays emitted by the light sources 138, 140, 142 are incident on the surface 174 of the light conditioner 106 at a substantial angle (Θ₁) from normal 172 to the surface 174. Thus, a large proportion of the light emitted directly from the light sources 138, 140, 142 undergoes multiple reflections off A) the surface 174 of the light conditioner 106, and B) the reflective surfaces 132, 134, 136 of the substrate 112. In this manner, light (λ) may be better dispersed and/or color-mixed by means of 1) the air cavity 156, 2) the character of the substrate's reflective surfaces 132, 134, 136, and 3) the character of the light conditioner's surface 174. In most cases, better light dispersion and/or color-mixing enables the backlight 104 to provide a backlight of more uniform color and luminance.

The vertical surfaces 158, 160, 162 defining the perimeter of the backlight 104 are preferably reflective so that light does not stray from the perimeter of the backlight 104.

The substrate 112 may be assembled from a plurality of like components 114, 116, 118, as shown in FIGS. 1 & 3. Alternately, it may be assembled from a plurality of different components 400, 402, as shown in FIG. 4, or as an integrated piece (not shown).

The substrate 112 for the backlight 104 may be formed using various materials, including, for example, a metal such as aluminum. Preferably, the substrate's material(s) are chosen to give it a substantially rigid and thermally conductive structure. In this manner, the substrate 112 may help to disperse the heat that is generated as a result of its reflective side 132, 134, 136 being bombarded by light rays. If additional heat dissipating elements (e.g., heat sinks 164, 166, 168) are needed, they may be coupled to either or both of the generally horizontal or generally vertical surfaces of the substrate 112. It is noted that the types and forms of heat dissipating elements shown are exemplary only.

To aid in dispersing and/or color mixing light within the cavity 156, the reflective side 132, 134, 136 of the substrate 112 may take various forms. For example, its reflective surface 132, 134, 136 may be a diffused reflective surface, a specular reflective surface, a polarizing reflective surface, or some combination thereof. Different reflective surfaces, such as the facing reflective surfaces 144, 150 within the recess 122, may take different forms.

In one embodiment, a diffused reflective surface may take the form of a uniform diffused surface (i.e., a diffused surface that provides substantially the same diffusion at any point of the surface). In another embodiment, a diffused reflective surface may take the form of a dot pattern of diffused reflective surfaces. In this latter case, a specular reflective layer may be positioned below the dot pattern for the purpose of directing light that leaks past the dot pattern back into the cavity 156. By way of example, the specular reflective layer may take the form of a specular coating or film applied to the substrate 112.

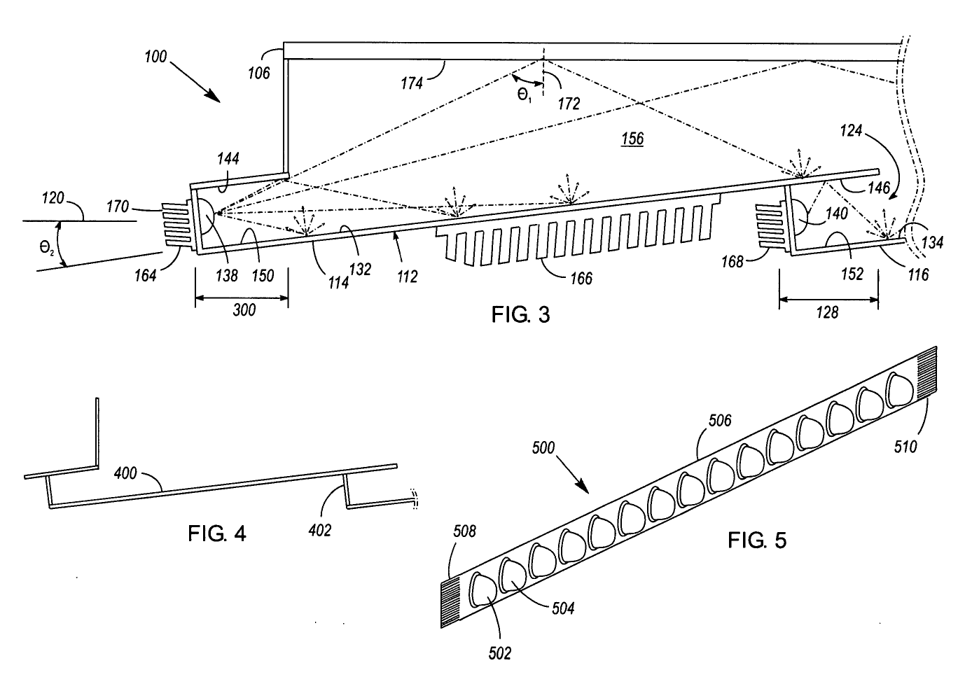

As shown in FIG. 3, the overlapping panels 112, 114, 116 of the backlight 104 may each form an angle, Θ₂ with an imaginary surface 120 that bisects the overlapping panels 112, 114, 116. In one embodiment of the backlight 104, the angle Θ₂ is between 0° and 30°.

The light sources 138, 140, 142 of the backlight 104 may take various forms, which forms may be used alone, or in combination with other forms. In one embodiment, the light sources 138, 140, 142 may take the form of arrays 500 of light-emitting diodes (LEDs). See FIG. 5. The individual LEDs (e.g., 502, 504) of an array 500 may be of the same or different colors. For example, all of the LEDs 502, 504 in an array 500 may emit white light. Or, an LED array 500 may comprise a plurality of differently colored LEDs 502, 504, each of which emits, for example, red, green or blue light. When an LED array 500 comprises differently colored LEDs 502, 504, the drive signals of the differently colored LEDs 502, 504 may be adjusted to control the color point of the mixed light emitted by the LED array 500.

In one useful combination of LEDs, differently colored LEDs may emit dominant light wavelengths between 450 and 490 nanometers (nm) (bluish light), between 510 and 550 nm (greenish light), and between 610 and 650 nm (reddish light). In another useful combination of LEDs, differently colored LEDs may emit dominant light wavelengths between 450 and 480 nanometers (bluish light), between 480 and 520 nm (bluish-green light), between 520 and 550 nm (greenish light), and between 610 and 650 nm (reddish light).

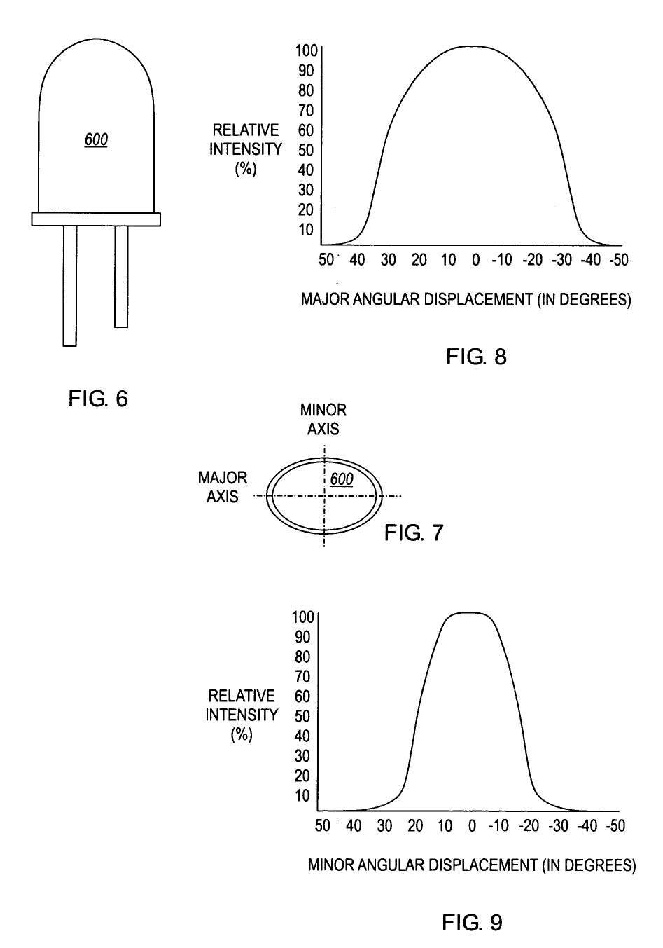

In one embodiment, the luminous intensity spatial distribution of an LED may be rotationally symmetric about the LED's optical axis. This is typical of LEDs having a round horizontal cross-section. Alternately, and as shown in FIGS. 6-9, an LED 600 may have an oval-shaped luminous intensity spatial distribution, with distinct major and minor axes in its luminous intensity spatial distribution. See, for example, the plots of luminous intensity (FIGS. 8 & 9) for the major and minor axes of the oval-shaped LED shown in FIGS. 6 & 7. An LED 600 having an oval-shaped luminous intensity spatial distribution is useful in that the LED's major axis can be oriented substantially horizontally to the rather thin plane of the backlight 104, and the LED's minor axis can be oriented substantially vertically to the plane of the backlight 104, thereby enabling the LED 600 to illuminate a wider “strip” of the substrate 112 and mitigating illumination banding affects as a result of LED spacing. LEDs having oval-shaped luminous intensity spatial distributions can also sometimes decrease the number of LEDs that must be provided in an array 500.

It has been found through experimentation that, for backlights having thin depths and relatively large expanses (e.g., LCD television backlights), it is advantageous to fit a backlight 104 having a substrate of overlapping panels with oval-shaped LEDs 600 having luminous intensity spatial distributions with a viewing angle of between 20° and 90° in their minor axes and between 60° and 180° in their major axes.

The light sources 138, 140, 142 of the backlight 104 may take a number of forms. For example, a light source 138 may take the form of an array 500 of LEDs 502, 504 that is mounted on a substrate 506 having electrical connections 508, 510 thereon (e.g., as shown in FIG. 5). This LED substrate 506 may be mounted to, or adjacent, the substrate 112.

In one embodiment, the substrate 506 on which the LEDs 502, 504 are mounted may be a flexible printed circuit (FPC). In another embodiment, the substrate 506 on which the LEDs 502, 504 are mounted may be a metal core printed circuit board (MCPCB). In the latter case, the MCPCB may function not only as the LED substrate 506, but as part of the substrate 112. Otherwise, a substrate 506 such as a FPC may be mounted to (or abutted to) an aluminum substrate with a dielectric interposed there-between.

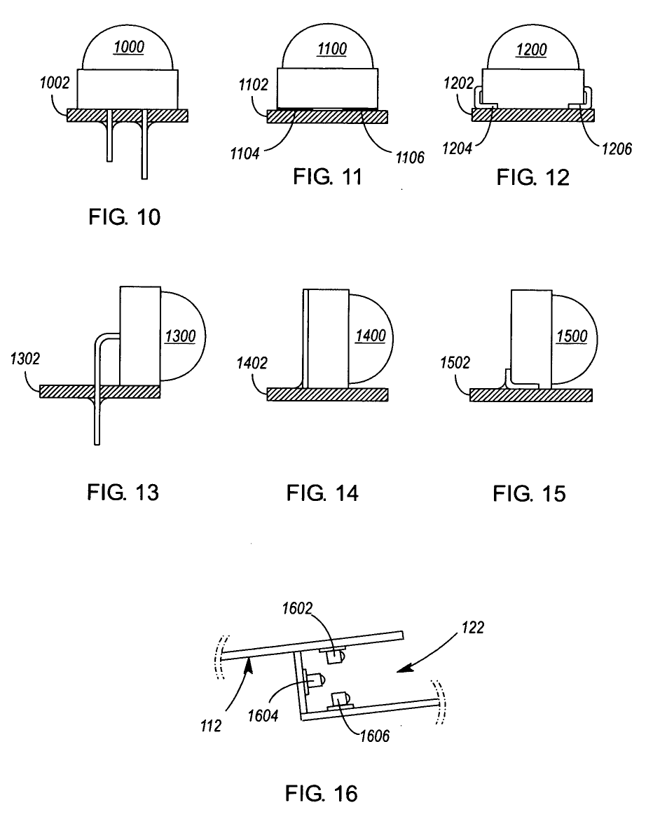

The LEDs 502, 504 may be mounted to the substrate 506 in a variety of ways, including by through-hole or surface-mount methods. FIG. 10 illustrates the mounting of an exemplary through-hole LED 1000 to a substrate 1002. FIGS. 11 & 12 illustrate the mounting of two different surface-mount LEDs 1100, 1200 to a substrate 1102, 1202 (with the first LED 1100 comprising a pair of pads 1104, 1106 on its underside, and with the second LED 1200 comprising a pair of contacts 1204, 1206 that wrap around and under the edges of the LED's package). Note that with each of the LEDs 1000, 1100, 1200 illustrated in FIGS. 10-12, the LED's optical axis extends perpendicularly from the substrates 1002, 1102, 1202.

FIG. 13 illustrates the mounting of a right-angle through-hole LED 1300 to a substrate 1302. As shown, the LED 1300 may be mounted such that it overhangs an edge of the substrate 1302 on which it is mounted, which in some cases may allow it to be mounted closer to (or extend into) the cavity 156. FIGS. 14 & 15 illustrate the mounting of various right-angle surface-mount LEDs 1400, 1500 to a substrate 1402, 1502. Note that with each of the LEDs 1300, 1400, 1500 illustrated in FIGS. 13-15, the LED's optical axis extends parallel to the substrates 1302, 1402, 1502.

Although the LED array 500 shown in FIG. 5 comprises only a single row of LEDs 502, 504, an LED array 500 could alternately comprise multiple rows of LEDs, with the rows forming parallel columns, or with the LEDs of different rows forming a zigzag or other pattern, as desired to achieve a uniform (or non-uniform) distribution of light intensity and color for the given type or types of LEDs that form the array 500.

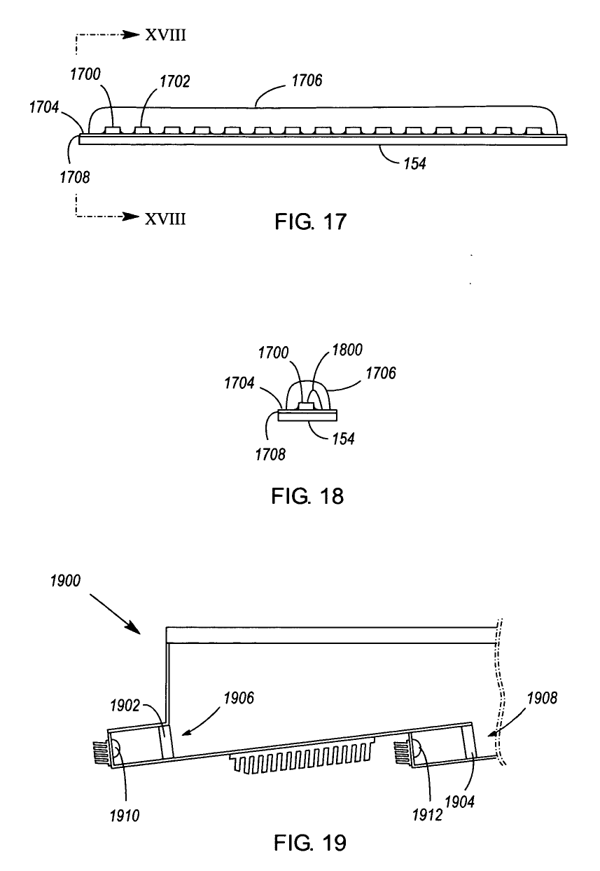

FIGS. 17 and 18 illustrate an alternative to mounting packaged LEDs 502, 504 on a substrate 506. As shown, a plurality of LED chips 1700, 1702 may be attached to a substrate 1704, and surface mounts and/or wirebonds 1800 may be used to electrically couple the LED chips 1700, 1702 to traces or pads on the substrate 1704. An encapsulant 1706 may placed over the LED chips 1700, 1702 to protect them and form a lens. The encapsulant 1706 may be placed using various manufacturing methods, such as: glob-top, molding, casting, or vacuum printing encapsulation. In one embodiment, the substrate 1704 on which the LED chips 1700, 1702 are mounted may be a flexible printed circuit (FPC). In another embodiment, the substrate 1704 on which the LED chips 1700, 1702 are mounted may be a metal core printed circuit board (MCPCB). In the latter case, the MCPCB may function not only as the LED chip substrate 1704, but as part of the substrate 112. Otherwise, a substrate 1704 such as a FPC may be mounted to (or abutted to) an aluminum substrate with a dielectric 1708 interposed there-between.

In one embodiment, an array of LEDs 502, 504 or LED chips 1700, 1702 is mounted on a surface that is substantially perpendicular to one of the plurality of overlapping panels 114, 116, 118 of the substrate 112. See FIG. 3. Alternately, or additionally, an array of LEDs 1300, 1400, 1500 may be mounted to the reflective side 152 of the substrate 116, or to one of the overhanging surfaces 146 in one of the recesses 124. Preferably, however, all of the light sources 138, 140, 142 are positioned in the recesses. As shown in FIG. 16, arrays 1602, 1604, 1606 of different LED types may be mounted to all of the surfaces within a recess 122.

As previously mentioned, one or more heat dissipating elements 164, 166, 168 may be coupled to the backlight 104. By way of example, the heat dissipating elements 164, 166, 168 may be attached near the light sources 138, 140, 142, or to a side of the substrate 112 opposite its reflective side 132, 134, 136. In FIGS. 1-3, the heat dissipating elements 164, 166, 168 are coupled to the substrate 112. However, the heat dissipating elements 164, 166, 168 could also or alternately be coupled directly to one or more substrates 506 on which the light sources 138, 140, 142 are mounted.

The heat dissipating elements 164, 166, 168 may conduct heat away from the backlight 104 by convection and radiation. In some embodiments, the heat dissipating elements 164, 166, 168 may comprise a plurality of fins separated by air gaps 170. If the fins are oriented such that the gaps between them are substantially aligned with the direction of gravity when the LCD 100 and backlight 104 are in use, hot air may rise in the air gaps 170 and pull up cooler air from the bottoms of the air gaps 170.

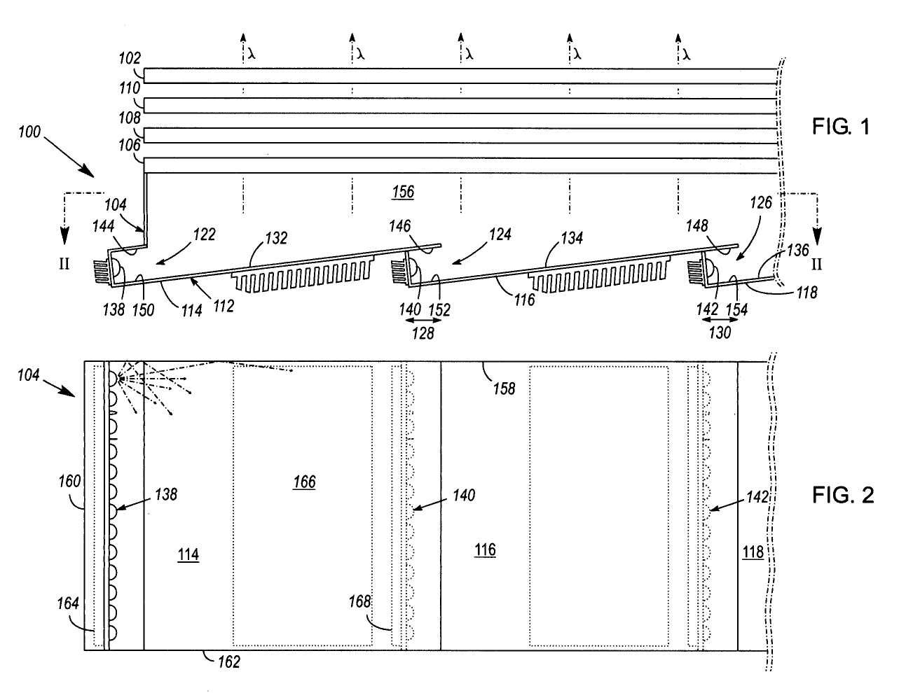

In one embodiment, the backlight 104 preferably comprises reflective elements, films or coatings that are applied to, or positioned adjacent, the external edges 158, 160, 162 of the backlight 104. See FIG. 2. In this manner, light rays may be prevented from transmitting through, or being absorbed by, the external edges 158, 160, 162 of the backlight 104, or may be reflected back into the backlight 104. By way of example, the reflective elements, films or coatings may be light diffusing or specular.

FIG. 19 illustrates an alternate backlight embodiment 1900, wherein light conditioners 1902, 1904 are positioned in or about the recesses 1906, 1908 of a backlight 1900. In this manner, the light conditioners 1902, 1904 can receive and condition the light emitted by the light sources 1910, 1912. By way of example, the light conditioners 1902, 1904 may comprise one or more elements, sheets or films that are light diffusers, holographic light diffusers or prismatic. In some cases, the light conditioners 1902, 1904 may be advantageously used to pre-mix the light emitted by differently colored LEDs.

Although the apparatus shown in FIGS. 1-3 and 19 has been described in the context of backlighting, it may be used in various applications where a light-emitting apparatus is needed. For example, a mood light or tiled light source could be assembled similarly to the backlight 104.

Depending on its configuration, the backlight 104 may provide a variety of advantages over other backlighting options. For example, as compared to some backlights, the backlight 104 provides additional surfaces for injecting light into the backlight (and the additional surfaces are distributed across the surface of the backlight). Further, given that light may be injected into the backlight from locations interior to the backlight 104, and not just from its perimeter, the light sources 138, 140, 142 used to light the backlight may sometimes take the form of low power LEDs, such as LEDs producing less than 200 milliWatts (mW) each. This may not only decrease the cost of the light sources 138, 140, 142, but it may 1) decrease the power consumed per square area of backlight surface, 2) reduce the amount of heat that a backlight generates, 3) increase the efficiency of the light sources, and 4) increase the lifetimes of any organic or polymeric components in a display system.

Lower power light sources also tend to have smaller form-factors, thereby making it possible to position them at a finer center-to-center pitch. In backlights that rely on mixing differently colored lights (e.g., red, green and blue lights), an ability to position them closer to one another increases the likelihood that their lights will thoroughly mix before being refracted from the light-emitting surface of the backlight.

In some embodiments, the lower power consumption and heat production of the backlight 104 will enable it to be built with smaller or no heat dissipating elements, thereby reducing the volume of space required to implement the backlight.

In some embodiments, the backlight 104 may also reduce the lengths of paths that light rays have to travel before entering a light conditioning element 106 that is adjacent to the backlight. Often, shorter length light paths will reduce the amount of light that is converted into heat and then absorbed by the backlight 104.

What is claimed is:

1. Light-emitting apparatus, comprising:
a substrate having i) a plurality of overlapping panels that form acute angles with respect to an imaginary surface that bisects the overlapping panels, and ii) a plurality of recesses formed between overlapping portions of the overlapping panels, wherein the recesses are open to a first side of the substrate, and wherein the first side of the substrate has a reflective surface; and
a plurality of light sources, positioned to emanate light from the recesses.

2. The light-emitting apparatus of claim 1, wherein at least one of the light sources is positioned such that its emitted light is at least partially blocked by an overhanging surface of one of the recesses.

3. The light-emitting apparatus of claim 1, further comprising a light conditioner, positioned over the first side of the substrate so as to condition and pass light reflected from the first side of the substrate.

4. The light-emitting apparatus of claim 3, wherein at least one of the light sources is positioned such that its emitted light is at least partially blocked by an overhanging surface of one of the recesses, and wherein the position(s) of the light source(s) and height(s) and width(s) of the recess(es) cause any light traveling directly between the light source(s) and the light conditioner to be reflected from the light conditioner toward the first side of the substrate.

5. The light-emitting apparatus of claim 1, wherein each recess comprises at least first and second reflective surfaces, positioned to face each other from opposite sides of each light source.

6. The light-emitting apparatus of claim 1, wherein the reflective surface is a diffused reflective surface.

7. The light-emitting apparatus of claim 6, wherein the diffused reflective surface comprises dot patterns of diffused reflective surfaces.

8. The light-emitting apparatus of claim 7, further comprising a specular reflective layer positioned below the dot patterns of diffused reflective surfaces.

9. The light-emitting apparatus of claim 6, wherein the diffused reflective surface is a uniform diffused surface.

10. The light-emitting apparatus of claim 1, wherein the first reflective surface is a specular reflective surface.

11. The light-emitting apparatus of claim 1, wherein the first reflective surfaces is a polarizing reflective surface.

12. The light-emitting apparatus of claim 1, wherein each light source comprises a plurality of light-emitting diodes (LEDs).

13. The light-emitting apparatus of claim 12, wherein the LEDs comprise differently colored LEDs.

14. The light-emitting apparatus of claim 13, wherein ones of the LEDs have a luminous intensity spatial distribution having rotational symmetry about its optical axis.

15. The light-emitting apparatus of claim 13, wherein ones of the LEDs have an oval-shaped luminous intensity spatial distribution, with distinct major and minor axes in their luminous intensity spatial distribution.

16. The light-emitting apparatus of claim 15, wherein the oval-shaped luminous intensity spatial distribution has a viewing angle of between 20° and 90° in the minor axis, and a viewing angle of between 60° and 180° in the major axis.

17. The light-emitting apparatus of claim 15, wherein the minor axis of the luminous intensity spatial distribution is oriented substantially perpendicular to the reflective surface of the substrate, and wherein the major axis of the luminous intensity spatial distribution is oriented substantially parallel to the reflective surface.

18. The light-emitting apparatus of claim 12, wherein the LEDs forming a given one of the light sources comprise a plurality of LED chips formed on a common substrate, with the LED chips being covered by an encapsulant.

19. The light-emitting apparatus of claim 12, wherein the LEDs forming a given one of the light sources are mounted on a substrate that is perpendicular to the LEDs' optical axes.

20. The light-emitting apparatus of claim 12, wherein the LEDs forming a given one of the light sources are mounted on a substrate that is parallel to the LEDs' optical axes.

21. The light-emitting apparatus of claim 1, wherein at least one of the light sources is mounted on a surface that is substantially perpendicular to one of the plurality of overlapping panels of the substrate.

22. The light-emitting apparatus of claim 1, wherein at least one of the light sources is mounted to the first side of the substrate.

23. The light-emitting apparatus of claim 1, wherein at least one of the light sources is mounted to one of the overhanging surfaces, within one of said recesses.

24. The light-emitting apparatus of claim 1, wherein the light sources in at least some of the recesses are mounted on two or more surfaces of the recesses.

25. The light-emitting apparatus of claim 1, further comprising one or more heat dissipating elements that are coupled to a second side of the substrate, opposite the first side.

26. The light-emitting apparatus of claim 1, further comprising a number of heat dissipating elements that are coupled to the light sources.

27. The light-emitting apparatus of claim 1, wherein the overlapping panels form acute angles of between 0° and 30° with said imaginary surface.

28. The light-emitting apparatus of claim 1, further comprising second light conditioners positioned in or about said recesses to receive and condition the light emitted by the light sources.

29. The light-emitting apparatus of claim 28, wherein at least one of the second light conditioners is a light diffuser.

30. The light-emitting apparatus of claim 28, wherein at least one of the second light conditioners is prismatic.

31. The light-emitting apparatus of claim 28, wherein at least one of the second light conditioners is a holographic light diffuser.

32. The light-emitting apparatus of claim 1, wherein the substrate comprises a plurality of component parts.

33. A liquid crystal display (LCD), comprising:
a liquid crystal display panel having a plurality of LCD elements; and
a backlight positioned behind the display panel, the backlight comprising:
a substrate having i) a plurality of overlapping panels that form acute angles with respect to an imaginary surface that bisects the overlapping panels, and ii) a plurality of recesses formed between overlapping portions of the overlapping panels, wherein the recesses are open to the first side of the substrate, and wherein the first side of the substrate has a reflective surface; and
a plurality of light sources, positioned to emanate light from the recesses.

34. The LCD of claim 33, wherein at least one of the light sources is positioned such that its emitted light is at least partially blocked by an overhanging surface of one of the recesses.

35. The LCD of claim 33, further comprising a light conditioner, positioned over the first side of the substrate so as to condition and pass light reflected from the first side of the substrate.

36. The LCD of claim 35, wherein at least one of the light sources is positioned such that its emitted light is at least partially blocked by an overhanging surface of one of the recesses, and wherein the position(s) of the light source(s) and height(s) and width(s) of the recess(es) cause any light traveling directly between the light source(s) and the light conditioner to be reflected from the light conditioner toward the first side of the substrate.

37. The LCD of claim 35, wherein the light conditioner comprises one or more light diffusing layers.

38. The LCD of claim 35, wherein the light conditioner comprises one or more prismatic layers.

39. The LCD of claim 35, wherein the light conditioner comprises one or more light polarizing layers.
